(19) United States
(12) Patent Application Publication
(10) Pub. No.: US 2025/0380006 A1
(43) Pub. Date: Dec. 11, 2025

(54) TRANSFORM KERNEL TYPE SELECTION FLEXIBILITY

(71) Applicant: GOOGLE LLC, Mountain View, CA (US)

(72) Inventors: Lin Zheng, Waterloo (CA); Jingning Han, Santa Clara, CA (US); Yaowu Xu, Saratoga, CA (US)

(21) Appl. No.: 19/209,116

(22) Filed: May 15, 2025

Related U.S. Application Data
(60) Provisional application No. 63/656,179, filed on Jun. 5, 2024.

(51) Int. Cl. H04N 19/625; H04N 19/159

(52) U.S. Cl. CPC H04N 19/625; H04N 19/159

(57) ABSTRACT

A long transform type to apply to a long side of a transform block and a short transform type to apply to a short side of the transform block are identified. Identifying the long transform type and the short transform type includes determining that the long side is equal to a first threshold value; and, in response to determining that the long side is equal to the first threshold value, coding the long transform type, the long transform type being one of a discrete cosine transform or an identity transform. The long transform type and the short transform type are then applied.

### CROSS REFERENCE TO RELATED APPLICATIONS

This application claims the benefit of and priority to U.S. Provisional Patent Application Ser. No. 63/656,179, filed Jun. 5, 2024, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

One aspect of the disclosed implementations is a method that includes identifying a long transform type to apply to a long side of a transform block and a short transform type to apply to a short side of the transform block. Identifying the long transform type and the short transform type includes determining that the long side is equal to a first threshold value; and in response to determining that the long side is equal to the first threshold value, coding the long transform type, the long transform type being one of a discrete cosine transform or an identity transform. The method further includes applying the long transform and the short transform type.

One aspect of the disclosed implementations is a device that includes a processor. The processor is configured to execute instructions to identify a long transform type to apply to a long side of a transform block and a short transform type to apply to a short side of the transform block. To identify the long transform type and the short transform type includes to determine that the long side is equal to a first threshold value; and, in response to determining that the long side is equal to the first threshold value, code the long transform type, the long transform type being one of a discrete cosine transform or an identity transform. The processor is further configured to apply the long transform and the short transform type.

One aspect of the disclosed implementations is a non-transitory computer-readable storage medium, including executable instructions that, when executed by a processor, perform operations including identifying a long transform type to apply to a long side of a transform block and a short transform type to apply to a short side of the transform block. Identifying the long transform type and the short transform type includes determining that the long side is equal to a first threshold value; and in response to determining that the long side is equal to the first threshold value, coding the long transform type, the long transform type being one of a discrete cosine transform or an identity transform. The operations further include applying the long transform and the short transform type.

These and other aspects of the present disclosure are disclosed in the following detailed description of the embodiments, the appended claims and the accompanying figures. It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is an illustration of examples of portions of a video frame.

FIG. 7A is a flowchart of a technique for flexibly selecting transform kernel types.

FIG. 7B is a flowchart of a technique for signaling transform types for a transform block using entropy coding.

FIG. 8 is a flowchart of a technique for coding a transform block.

FIG. 9 is a flowchart of a technique for selecting a transform set based on transform block dimensions.

### DETAILED DESCRIPTION

Video compression schemes may include breaking images, or video frames, into smaller portions, such as video blocks, and generating an encoded bitstream using techniques to limit the information included for respective video blocks thereof. The encoded bitstream can be decoded to re-create the source images from the limited information.

Video stream encoding and decoding involve identifying differences between a current block and either spatially or temporally adjacent blocks. These differences, referred to as residuals, are a key part of the encoding and decoding process. The encoding process transforms these residuals into the transform domain using transform kernels. Transform kernels convert spatial data into frequency data, allowing for more efficient compression by concentrating the significant information into fewer coefficients.

During decoding, the process is reversed. The decoder extracts the encoded residuals from the bitstream and applies the inverse of the transform kernels used during encoding. This inverse transformation converts the frequency data back into the spatial domain, reconstructing the residuals. The reconstructed residuals are then used to restore the original video block by adding them to the predicted block, thereby recreating the source images with high fidelity.

In conventional video codecs, while several transform types may be available, which transform types may be used for coding a transform block may be limited by the size or by one dimension of the transform block. For example, whereas 16 different transform kernel types may be available in a codec, for transform block sizes where the long side is greater or equal to a threshold size (e.g., 32), only very limited transform kernel types may be allowed. Such limitation may be hardware related-such as hardware latencies in hardware-implemented codecs.

To illustrate, for transform blocks of sizes 64×N or N×64, regardless of the value of N, only the discrete cosine transform (DCT) kernel type may be allowed on both of the horizontal and the vertical directions; and for transform blocks of sizes 32×N or N×32, only the DCT or Identity (IDT) transform kernel types may be allowed on both of the horizontal and the vertical directions. These limitations are imposed because only the DCT is supported for block sizes where at least one of the dimensions is 64, and only the DCT and the IDTX are supported for block sizes where at least one of the dimensions is 32. Table I lists the transform (i.e., transform types or transform kernels) allowed in a conventional implementation.

TABLE I

| | Allowed Transform |
|---|---|
| Transform Block Size | Types |
| 64 × 64, 64 × 32, 32 × 64, 64 × 16, 16 × 64, | DCT_DCT |
| 64 × 8, 8 × 64, 64 × 4, 4 × 64 | |
| 32 × 2, 32 × 16, 16 × 32, 32 × 8, 8 × 32, | DCT_DCT, IDTX |
| 32 × 4, 4 × 32 | |

Table I should be understood as follows: if a transform block is of size M×N, then the allowed transform kernel types for the block are given by K1_K2, where M is the horizontal dimension or width of the transform block; N is the vertical dimension or height of the transform block; K1 is the kernel applied in the vertical direction; and K2 is the kernel applied in the horizontal direction. DCT_DCT means that the DCT kernel is applied in both directions. IDTX means that the identity kernel is applied in both directions.

Such conventional techniques are not optimal as they significantly limit the flexibility of transform selection, which is crucial for efficient video coding. The restriction to specific transform types based on block size (e.g., the maximum dimension of the transform block) prevents the encoder from selecting the most efficient transform for a given block of video data. This can lead to suboptimal compression performance, as the transform chosen may not be the best fit for the spatial characteristics of the block. Additionally, the lack of flexibility in transform selection can result in higher bit rates and reduced video quality, as the encoder is unable to fully exploit the potential of different transform types for different block sizes.

Implementations according to this disclosure solve problems such as these by introducing a flexible transform selection mechanism that allows different transform kernel types to be independently selected for the long side and short side of a transform block. This approach significantly increases the flexibility of transform selection, enabling more efficient compression by matching the transform type to the specific characteristics of the video block. Implementations according to this disclosure include encoding and decoding signals indicating the selected transform kernel types for both dimensions, allowing the decoder to accurately reconstruct the video data.

By accommodating a wider range of transform types for various block sizes, the teachings herein improve compression efficiency, reduces bit rates, and enhances overall video quality. Furthermore, the redesigned syntax signaling supports this increased flexibility without adding significant complexity to the decoding process, ensuring compatibility with existing hardware and software frameworks.

While the teachings herein are mainly described with respect to transform blocks with long sides equal to threshold values of 32 or 64, the disclosure is not so limited. The flexible transform selection mechanism, which independently selects transform kernel types for the long and short sides of a transform block, can be applied to transform blocks of any dimensions and with any threshold values for the long side. For example, the method can accommodate different block sizes or threshold values by defining appropriate transform type sets and coding schemes based on the block's dimensions, prediction mode, or other characteristics. This generalization allows codec to adapt to various video coding standards, hardware constraints, or application requirements, ensuring efficient compression and high video quality across diverse scenarios while maintaining the core principle of independent transform type selection for each dimension.

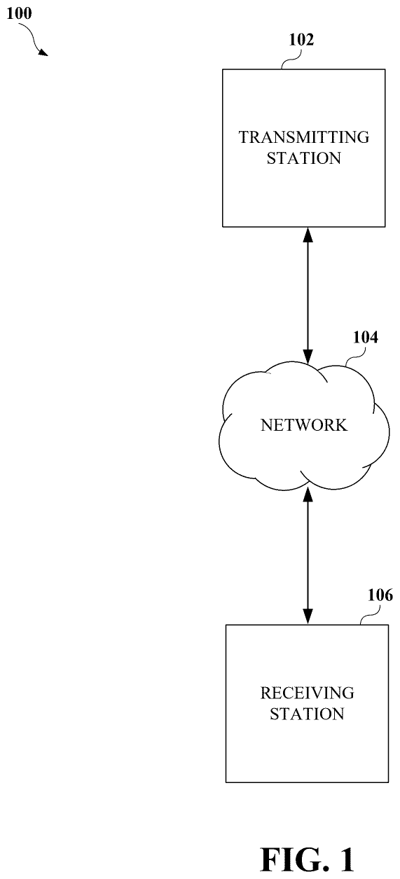

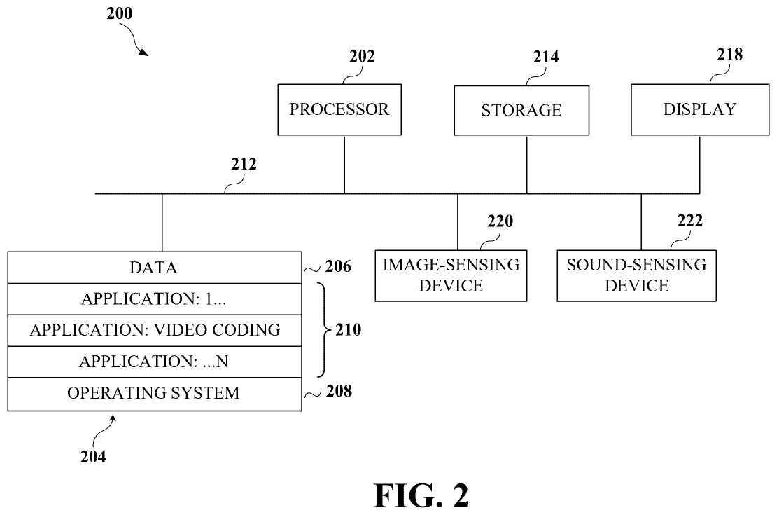

Further details of techniques for transform kernel type selection flexibility are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

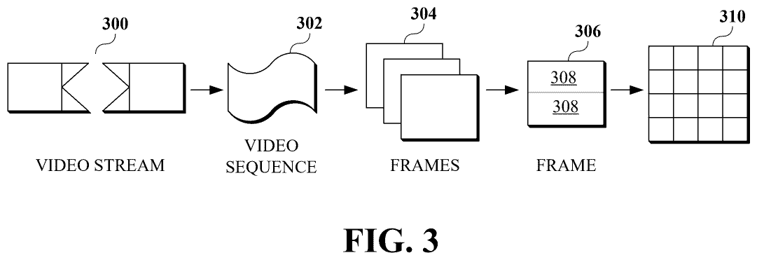

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

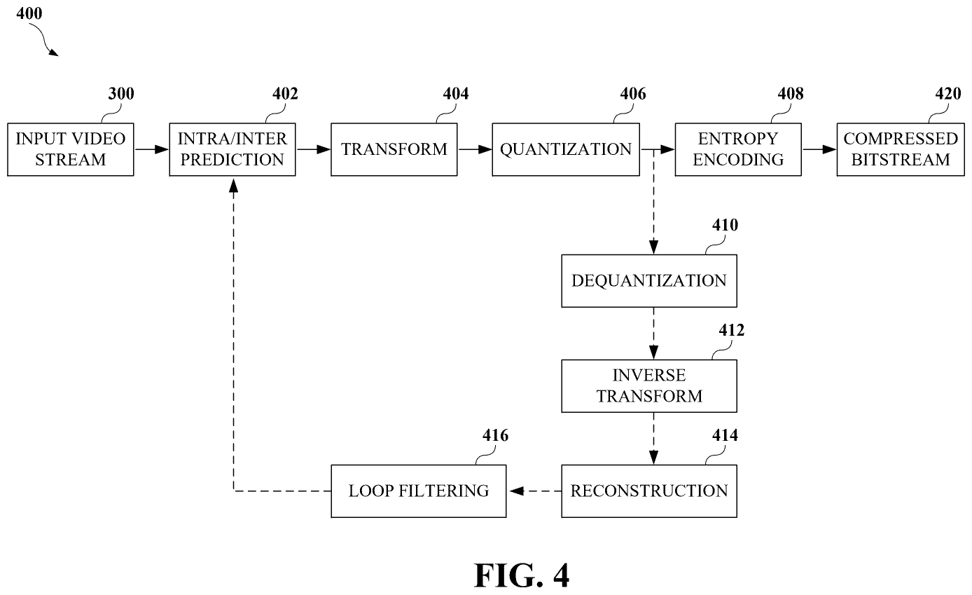

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

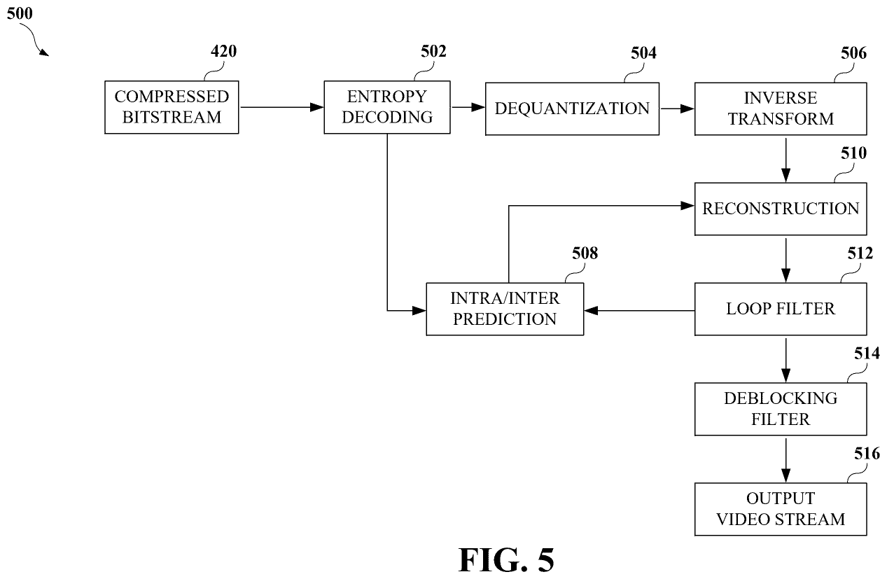

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters which may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514.

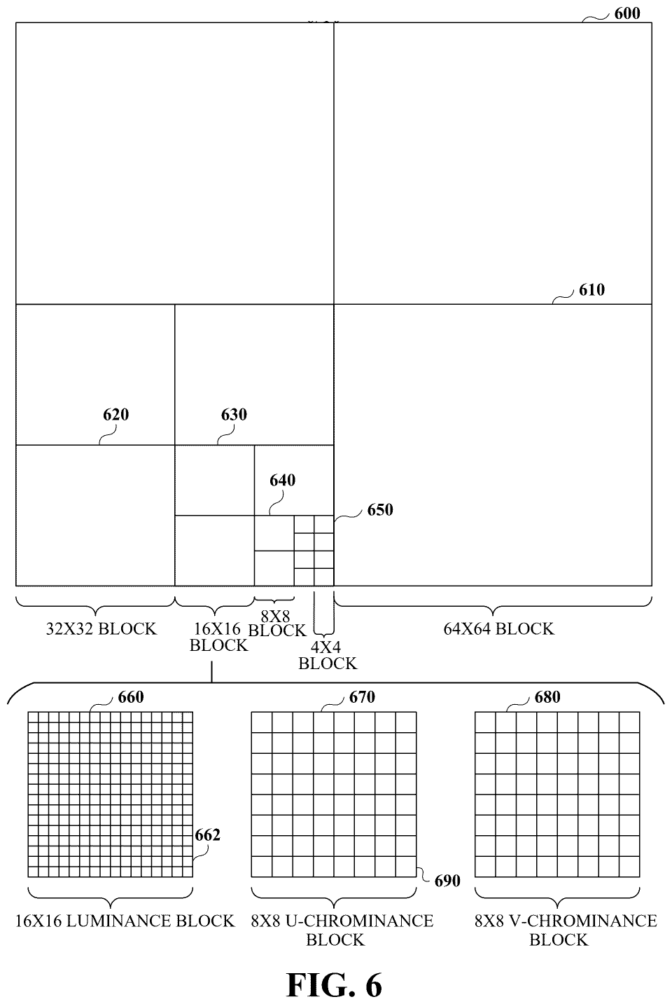

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 650. Each 4×4 block 650 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16-pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits. Although this disclosure is described in reference to the YUV color model, another color model may be used. Reducing spatial redundancy may include transforming a block into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

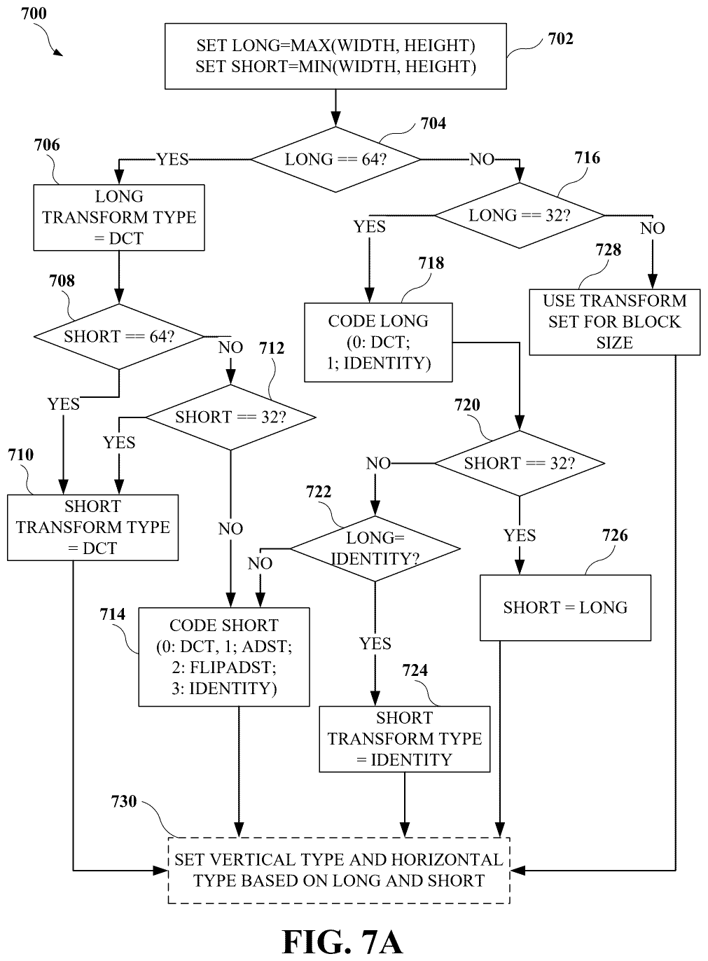

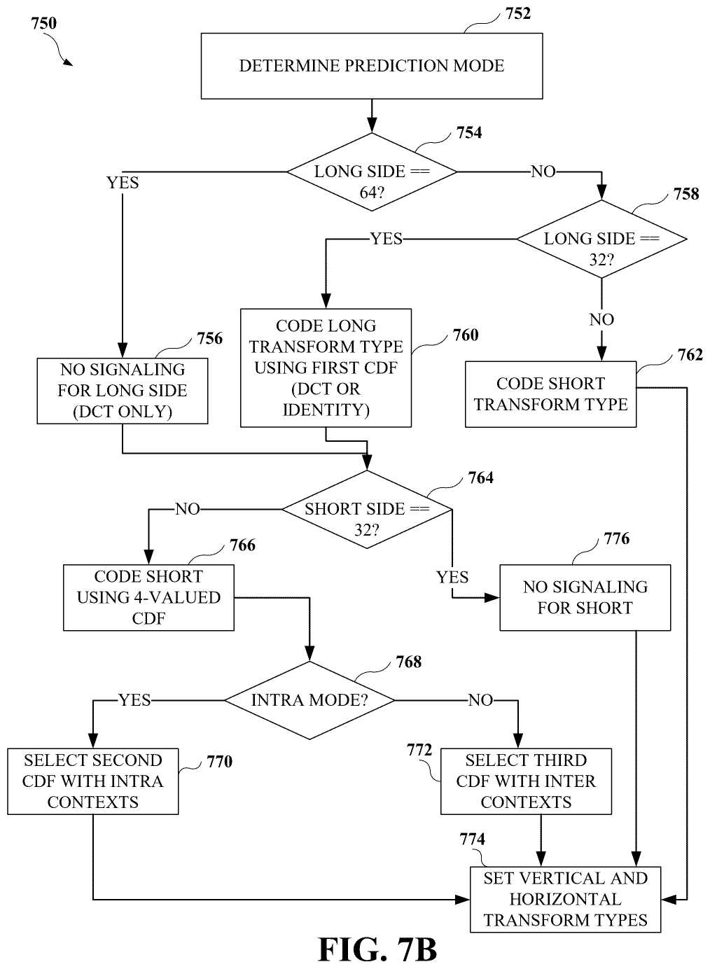

FIG. 7A is a flowchart of a technique 700 for flexibly selecting transform kernel types. The transform type selection is made with particular emphasis on enabling a wider range of transform types for transform blocks with a short side less than or equal to a threshold size (e.g., 16), while applying specific constraints when the long side equals a primary threshold or secondary threshold. For ease of explanation, the primary threshold and secondary threshold are exemplified as 64 and 32, respectively, in this disclosure. The technique enhances compression efficiency by adapting transform types to block dimensions, as further described with respect to FIG. 7A.

The technique 700 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 700. The technique 700 may be implemented in whole or in part in the transform stage 404 of the encoder 400 of FIG. 4 and/or the inverse transform stage 506 of the decoder 500 of FIG. 5. The technique 700 can be implemented using specialized hardware or firmware. Multiple processors, memories, or both, may be used.

A codec may include a set of available transform types. To illustrate, and without limitations, the set may include 16 different transform types, as further described below. Typically, an encoder may encode a transform type and a decoder may decode a transform type (or more accurately, an inverse transform type) from a block header.

The transform type can include a horizontal transform type (e.g., a kernel) to be applied to the rows of the transform block and a vertical transform type (e.g., a kernel) to be applied to the columns of the transform block, independently. A separable two-dimensional (2D) transform process can be applied to prediction residuals. For the forward transform (e.g., at an encoder), a one-directional (1D) vertical transform is first performed on each column of the input residual block, then a horizontal transform is performed on each row of the vertical transform output. For the backward transform (e.g., at a decoder), a 1D horizontal transform is first performed on each row of the input dequantized coefficient block, then a vertical transform is performed on each column of the horizontal transform output.

In an example, the transform kernels available in a codec, such as the Alliance for Open Media (AOMedia) Video 1 (AV1) codec, may include four different types of transforms: the DCT, an asymmetric discrete sine transform (ADST), a flipped version of the ADST (FLIPADST), and an identity transform (IDT). Each of these transforms (i.e., kernels) may be available at different sizes (e.g., 4-point, 8-point). For example, 4-, 8-, 16-, 32-, and 64-point DCT kernels may be available; 4-, 8-, and 16-point ADST and FLIPADST kernels may be available; and 4-, 8-, 16-, and 32-point identity transforms (IDTs) may be available. Again, more, fewer, or other kernels are possible. The disclosure herein uses H_, V_, and IDTX to refer to the identity transform (IDT) being applied to the horizontal dimension, vertical dimension, and both dimensions, respectively.

The DCT kernel is widely used in signal compression and is known to approximate the optimal linear transform, the Karhunen-Loeve transform (KLT), for consistently correlated data. The ADST, on the other hand, approximates the KLT where one-sided smoothness is assumed and can be naturally suitable for coding, inter alia, some intra-prediction residuals. Similarly, the FLIPADST can capture one-sided smoothness from the opposite end. The IDT can be used to accommodate situations where sharp transitions are contained in the block and where neither DCT nor ADST is effective. Also, the IDT, combined with other 1-D transforms, provides the 1-D transforms themselves, therefore allowing for better compression of horizontal and vertical patterns in the residual.

Accordingly, the available transform types may include sixteen 2D transforms comprising combinations of four 1D transforms as follows: DCT_DCT (transform rows with DCT and columns with DCT), ADST_DCT (transform columns with ADST and rows with DCT), DCT_ADST (transform columns with DCT and rows with ADST), ADST_ADST (transform rows with ADST and columns with ADST), FLIPADST_DCT (transform columns with FLIPADST and rows with DCT), DCT_FLIPADST (transform columns with DCT and rows with FLIPADST), FLIPADST_FLIPADST (transform rows with FLIPADST and columns with FLIPADST), ADST_FLIPADST (transform columns with ADST and rows with FLIPADST), FLIPADST_ADST (transform columns with FLIPADST and rows with ADST), IDTX (transform rows with identity and columns with identity), V_DCT (transform rows with identity and columns with DCT), H_DCT (transform rows with DCT and columns with identity), V_ADST (transform rows with identity and columns with ADST), H_ADST (transform rows with ADST and columns with identity), V_FLIPADST (transform rows with identity and columns with FLIPADST), and H_FLIPADST (transform rows with FLIPADST and columns with identity).

With respect to transform blocks having at least one dimension that is at least 32, the technique 700 implements the coding of transform types as defined in Table II.

TABLE II

| Transform Block Size | Allowed Transform Types |
|---|---|
| 64 × 64 / 64 × 32 / 32 × 64 | DCT_DCT |
| 64 × 16 / 64 × 8 / 64 × 4 | DCT_DCT/ ADST_DCT/ FLIPADST_DCT / H_DCT |
| 16 × 64 / 8 × 64 / 4 × 64 | DCT_DCT/ DCT_ADST/ DCT_FLIPADST / V_DCT |
| 32 × 32 | DCT_DCT / IDTX |
| 32 × 16 / 32 × 8 / 32 × 4 | DCT_DCT / ADST_DCT / FLIPADST_DCT / H_DCT / IDTX / V_DCT / |
| | V_ADST / V_FLIPADST |
| 16 × 32/ 8 × 32 / 4 × 32 | DCT_DCT / DCT_ADST / DCT_FLIPADST/ V_DCT / IDTX / H_DCT / |
| | H_ADST / H_FLIPADST |

In some implementations, transform types are categorized into a transform set structure, defined by an enumeration named TxSetType, to streamline selection and signaling during encoding and decoding. The TxSetType enumeration includes the following sets, which may be represented using a compact notation where a plus sign (+) indicates multiple transform types included in the set, and a slash (/) pairs transform types for different block orientations (e.g., width or height as the long side). For example, “DCT_ADST+FLIPADST_DCT” denotes that the set includes the DCT_ADST transform type (e.g., for blocks with a long height and short width using DCT vertically and ADST horizontally) and the FLIPADST_DCT transform type (e.g., for blocks with a long width and short height using FLIPADST vertically and DCT horizontally). The sets are explicitly defined as follows: EXT_TX_SET_DCTONLY: Includes only the DCT_DCT transform type:
EXT_TX_SET_DCTONLY: Includes only the DCT_DCT transform type;
EXT_TX_SET_DCT_IDTX: Includes DCT_DCT and IDTX transform types
EXT_TX_SET_LONG_SIDE_64: Includes DCT_DCT+ADST_DCT/DCT_ADST +FLIPADST_DCT/DCT_FLIPADST+H_DCT/V_DCT for transform blocks with a long side equal to 64, where DCT_DCT applies to all such blocks; ADST_DCT, FLIPADST_DCT, and H_DCT apply when the width is 64 and the height is less than or equal to 16 (e.g., 64×16, 64×8, 64×4); and DCT_ADST, DCT_FLIPADST, and V_DCT apply when the height is 64 and the width is less than or equal to 16 (e.g., 16×64, 8×64, 4×64), with the slash (/) indicating orientation-dependent pairs;
EXT_TX_SET_LONG_SIDE_32: Includes DCT_DCT+IDTX+H_DCT/V_DCT+ADST_DCT/DCT_ADST+V_ADST/H_ADST+V_FLIPADST/H_FLIPADST for transform blocks with a long side equal to 32, where DCT_DCT and IDTX apply to specific block sizes (e.g., 32×32); H_DCT, ADST_DCT, FLIPADST_DCT, V_ADST, and V_FLIPADST apply when the width is 32 and the height is less than 32 (e.g., 32×16, 32×8, 32×4); and V_DCT, DCT_ADST, DCT_FLIPADST, H_ADST, and H_FLIPADST apply when the height is 32 and the width is less than 32 (e.g., 16×32, 8×32, 4×32), with the slash (/) indicating orientation-dependent pairs . . .
EXT_TX_SET_DTT4_IDTX: Includes discrete trigonometric transforms (DCT_DCT, ADST_DCT, DCT_ADST, ADST_ADST) and IDTX, excluding flipped transforms.
EXT_TX_SET_DTT4_IDTX_1DDCT: Includes discrete trigonometric transforms (DCT_DCT, ADST_DCT, DCT_ADST, ADST_ADST), IDTX, and 1D horizontal/vertical DCT (H_DCT, V_DCT).
EXT_TX_SET_DTT9_IDTX_1DDCT: Includes discrete trigonometric transforms with flipped variants (DCT_DCT, ADST_DCT, DCT_ADST, ADST_ADST, FLIPADST_DCT, DCT_FLIPADST, FLIPADST_FLIPADST, ADST_FLIPADST, FLIPADST_ADST), IDTX, and 1D horizontal/vertical DCT (H_DCT, V_DCT).
EXT_TX_SET_ALL16: Includes all 16 transform types described herein.

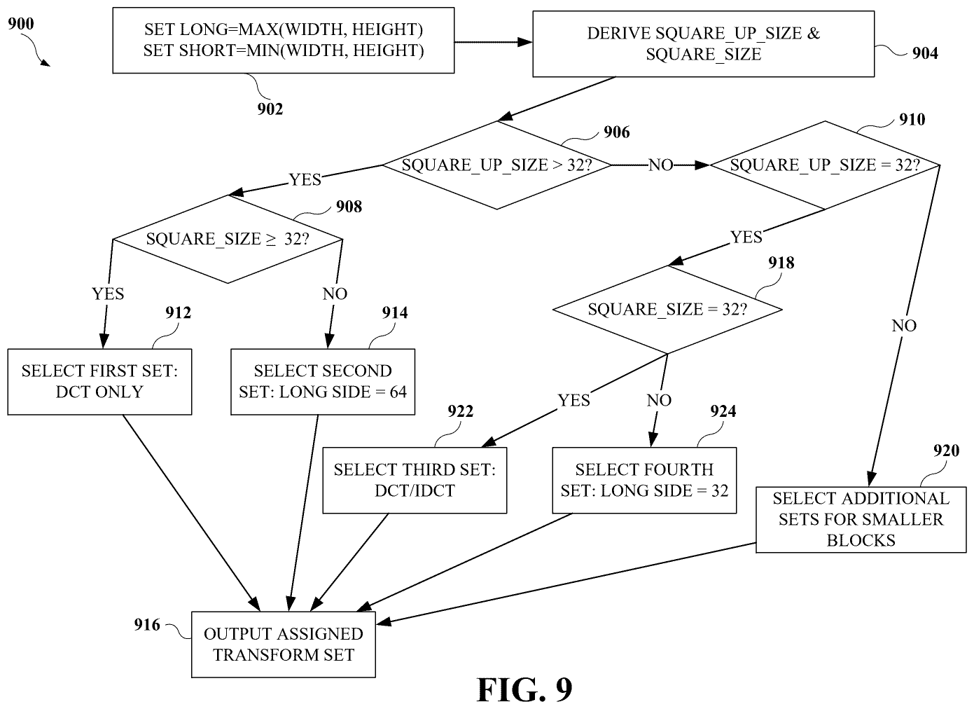

The use of transform sets, as defined by the TxSetType enumeration, enhances coding efficiency by limiting the number of permissible transform types for a given transform block based on its dimensions. By restricting the transform types to a predefined set (e.g., EXT_TX_SET_LONG_SIDE_64 or EXT_TX_SET_LONG_SIDE_32) rather than allowing all 16 possible transform types, fewer bits are required to signal the selected transform type in the compressed bitstream. This reduction in signaling overhead improves compression efficiency, enabling lower bitrates while maintaining high video quality, as the encoder and decoder operate within a constrained yet optimized set of transform options tailored to the characteristics of the block. The transform set is selected using mappings that derive a square-up size and a square size from the dimensions of the block, as further described with respect to FIG. 9.

The transform set may be selected by mapping the dimensions of the block to a square-up size (e.g., a larger square size derived from the maximum dimension, such as mapping to a power-of-two square like 64×64 for a 16×64 block) and a square size (e.g., a parameter reflecting the minimum dimension or a categorized block size, such as mapping to 16×16 for a 16×64 block). These mappings categorize transform blocks, including both square and rectangular blocks listed in Table II, into predefined size categories to determine the permissible transform types. For example, a 16×64 block may have a square-up size of 64 and a square size of 16, enabling selection of a transform set like EXT_TX_SET_LONG_SIDE_64 as described in FIG. 9. This mapping process, implemented via predefined functions, supports efficient transform set selection across diverse block sizes, as detailed in the pseudocode of Table IV.

The transform set may be selected by mapping the dimensions of the block to a square-up size (e.g., a larger square size derived from the dimensions, such as the maximum dimension mapped to a power-of-two square) and a derived size (e.g., a parameter reflecting the minimum dimension or a categorized block size). For example, for a rectangular block like 16×64, the square-up size may be 64, and the derived size may be 16, used to select the appropriate transform set as described in FIG. 9. This mapping accommodates both square and rectangular blocks, such as those listed in Table II, to determine the permissible transform types.

If the square-up size exceeds a threshold (e.g., 32), a first set (e.g., EXT_TX_SET_DCTONLY) or a second set (e.g., EXT_TX_SET_LONG_SIDE_64) may be selected based on the derived size; if equal to 32, a third set (e.g., EXT_TX_SET_DCT_IDTX) or a fourth set (e.g., EXT_TX_SET_LONG_SIDE_32) may be chosen. This structured categorization enhances flexibility and efficiency in transform type selection. Selecting the transform set can be as described with respect to FIG. 9.

While not specifically shown in FIG. 7A, the technique 700 may receive a transform block. When implemented by the encoder, the block may be generated by the transform stage 404, which may determine a partitioning of a residual block into one or more transform blocks according to a rate-distortion calculation. The dimensions (e.g., width and height) of the block may be encoded in a compressed bitstream, such as the compressed bitstream 420 of FIG. 4. When implemented by the decoder, receiving the block can include decoding, from the compressed bitstream, a width and a height of the transform block.

At 702, the technique 700 sets a variable LONG to the maximum of the width and height of the transform block, and the variable SHORT to the minimum of the width and the height of the transform block. At decision block 704, the technique 700 determines whether the long side of the transform block is equal to 64. If the long side is 64, the technique proceeds to 706, where the long transform type is set to DCT, as only the DCT transform is permitted for this size. At decision block 708, the technique 700 checks whether the short side is also equal to 64. If so, the technique moves to 710 to set the short transform type to DCT, as only the DCT_DCT combination is allowed for 64×64 transform blocks. If the short side is not equal to 64, at the decision block 708, the technique proceeds to decision block 712.

At the decision block 712, the technique 700 determines whether the short side is equal to 32. If so, at 714, the short transform type is set to DCT, as 64×32 blocks allow only DCT_DCT. If the short side is not equal to 32, the technique proceeds to 714, where the short transform type is coded from among DCT, ADST, FLIPADST, or IDT. This coding enables additional flexibility for transform blocks with short sides less than or equal to 16, such as 64×16 or 64×8, where alternate horizontal kernels like ADST or FLIPADST may improve compression efficiency. In an example, the technique 700 may code 0 for DCT, 1 for ADST, 2 for FLIPADST, and 3 for IDT.

If the long side is not equal to 64 at decision block 704, the technique 700 moves to decision block 716 to check whether the long side is equal to 32. If so, the technique 700 proceeds to 718 to code the long transform type as either DCT or IDT, where, in an example, DCT may be indicated by 0 and IDT by 1. From 718, the technique 700 proceeds to decision block 720 to check whether the short side is equal to 32. If the short side is 32, the technique 700 proceeds to 726, where the short transform type is set equal to the long transform type, enforcing that 32×32 transform blocks use either DCT_DCT or IDTX only.

If, at 720, the short side is not equal to 32, the technique proceeds to decision block 722, where it checks whether the long transform type is Identity. If so, at 724, the short transform type is also set to Identity, maintaining the IDTX restriction for 32λN or N×32 transform blocks where the long side is 32 and the long transform is IDT. If the long transform is DCT, the technique proceeds to 714 to code the short transform type from among DCT, ADST, FLIPADST, or IDT.

If the long side is neither 64 at decision block 704 nor 32 at decision block 716, the technique proceeds to 728. At 728, the transform block is handled using a transform set selected based on the full block size (rather than independently coding long and short sides), such as EXT_TX_SET_DTT9_IDTX_1DDCT. This applies, for example, to square or rectangular blocks smaller than 32×32.

From steps 710, 714, 724, 726, and 728 and the decision block 716, the technique 700 proceeds to 730. The step 730 finalizes the selection of transform kernel types to be applied to the transform block. At 730, the vertical and horizontal transform types are set based on the selected long and short transform types. For example, if the long side is vertical and was set to Identity, then a vertical identity transform kernel is selected; similarly, for horizontal Identity types. This step finalizes the assignment of transform types for both dimensions of the transform block. That is, if identity is determined to be one of the transform types, then the appropriate horizontal identity kernel or vertical identity kernel is selected (e.g., set) based on the whether the Identity type is decoded for the height or the width of the transform block. The step 730 is implemented by the decoder but not by the encoder since the encoder performs steps 702-728 after setting (e.g., selecting) the vertical transform type and the horizontal transform type.

The entropy coding of transform types uses cumulative distribution functions (CDFs) tailored to the transform block's dimensions and prediction mode (intra or inter). The transform block is associated with a residual block generated using an intra or inter prediction mode. The contexts for intra modes are based on transform size categories (EXT_TX_SIZES), defined by the long and short sizes of the transform block. For inter modes, the contexts include end-of-block contexts (EOB_TX_CTXS), based on the position of the last non-zero coefficient, and EXT_TX_SIZES. These CDFs support the entropy coding process described with respect to FIG. 7B.

FIG. 7B is a flowchart of a technique 750 for coding transform types for a transform block using entropy coding. For transform blocks with a long side less than 32, the technique codes a full two-dimensional transform type and skips separate short-side signaling, proceeding directly to set the transform types. The technique 750 enables efficient signaling of transform types selected by technique 700 (FIG. 7A) for blocks of varying sizes, using CDFs tailored to the block's long side and prediction mode.

In some implementations, technique 750 codes transform types using CDFs based on the transform block's long side. For blocks with a long side greater than or equal to 32, three CDFs are used:
aom_cdf_prob tx_ext_32_cdf[2][CDF_SIZE(2)]-Differentiates between intra and inter modes (0 for intra, 1 for inter) and indicates whether the transform type is DCT (0) or Identity (1) for the long side when it equals 32.
aom_cdf_prob intra_ext_tx_short_side_cdf[EXT_TX_SIZES][CDF_SIZE(4)]-Used for intra mode, indicates transform types [0: DCT, 1: ADST, 2: FLIPADST, 3: Identity] for the short side, with contexts based on EXT_TX_SIZES.
aom_cdf_prob inter_ext_tx_short_side_cdf[EOB_TX_CTXS][EXT_TX_SIZES][CDF_SIZE(4)]-Used for inter modes, indicates transform types [0: DCT, 1: ADST, 2: FLIPADST, 3: Identity] for the short side, with contexts based on EOB_TX_CTXS and EXT_TX_SIZES.

The CDF_SIZE(4) corresponds to the four transform types (DCT, ADST, FLIPADST, Identity) available when the long side is greater than or equal to 32, as defined in Table II. For blocks with a long side less than 32, the CDFs are defined as aom_cdf_prob intra_ext_tx_cdf[EXT_TX_SETS_INTRA][EXT_TX_SIZES][CDF_SIZE(TX_TYPES)] for intra modes and aom_cdf_prob inter_ext_tx_cdf[EXT_TX_SETS_INTER][EOB_TX_CTXS][EXT_TX_SIZES][CDF_SIZE(TX_TYPES)] for inter modes, where EXT_TX_SETS_INTRA and EXT_TX_SETS_INTER represent transform set contexts, EXT_TX_SIZES denotes transform size categories, EOB_TX_CTXS includes end-of-block contexts, and TX_TYPES represents the available transform types. These CDFs are used for entropy coding transform types selected according to Table II.

At 752, the technique 750 sets a variable LONG to the maximum of the width and height of the transform block, and the variable SHORT to the minimum of the width and height of the transform block. The prediction mode (intra or inter) corresponding to the transform block is assumed to be determined earlier, such as during the prediction stage 402 for encoding or decoded from the compressed bitstream 420 for decoding, as shown in FIG. 4.

At decision block 754, the technique 750 checks whether the long side is equal to 64. If yes, no coding is required for the long side, as only DCT is allowed, as shown at 756. The technique 750 then moves to decision block 764. If the long side is not equal to 64 at decision block 754, the technique 750 moves to decision block 758. At decision block 758, the technique 750 checks whether the long side is equal to 32. If yes, at 760, the technique 750 codes the long transform type using a first CDF (e.g., tx_ext_32_cdf), selecting between DCT and Identity based on the prediction mode (intra or inter). If the long side is not 32 at decision block 758, the technique 750 assumes smaller sizes and moves to 762 to code a full two-dimensional transform type using intra_ext_tx_cdf or inter_ext_tx_cdf based on the prediction mode, then proceeds to 774 to set the vertical and horizontal transform types based on the coded two-dimensional transform.

From 756 or 760, the technique 750 proceeds to decision block 764 to check if the short side is equal to 32. If yes, at 776, the technique 750 skips short-side signaling, as the short transform type is already determined by technique 700 (FIG. 7A), such as setting DCT for 64×32 blocks or matching the long transform type for 32×32 blocks. If the short side is not 32, the technique 750 codes, at 766, the short transform type using a 4-valued CDF (DCT, ADST, FLIPADST, IDT) by selecting, at 768, a CDF based on the prediction mode: intra_ext_tx_short_side_cdf with EXT_TX_SIZES for intra mode (770), or inter_ext_tx_short_side_cdf with EOB_TX_CTXS and EXT_TX_SIZES for inter mode (772). From 762, 776, or 770/772, the technique 750 proceeds to 774 to set the vertical and horizontal transform types based on the coded transform types, such as the two-dimensional transform from 762 or the long and short transform types from 756, 760, or 770/772.

When implemented by the encoder, the technique 750 encodes the transform types into the compressed bitstream using the appropriate CDF based on the prediction mode and contexts. For long sides less than 32, a full two-dimensional transform is encoded at 762; otherwise, long and short transform types are encoded separately at 756, 760, or 770/772. When implemented by the decoder, the technique 750 decodes the transform types using the same CDFs and contexts. At 774, the technique 750 sets the vertical and horizontal transform types based on the coded transform types, ensuring accurate reconstruction of the transform block.

Accordingly, selection of the probability model for signaling the transform kernel types for the long side and short side of the transform block can be as shown in the pseudocode of Table III.

TABLE III

| | |
|---|---|
| 1 | If the long side == 64 & the short side ≥ 32, then only DCT is |
| | allowed for both sides, and nothing is signaled |
| 2 | If the long side == 32, use tx_ext_32_cdf to signal if the transform |
| | kernel type along the long side is DCT or Identity transform |
| 3 | If the short side < 32, use intra_ext_tx_short_side_cdf or |
| | inter_ext_tx_short_side_cdf to signal if the transform kernel type |
| | along the short side is DCT, ADST, FLIPADST, or Identity |
| | transform (one of the total four types) for intra mode and inter mode, |
| | respectively. |

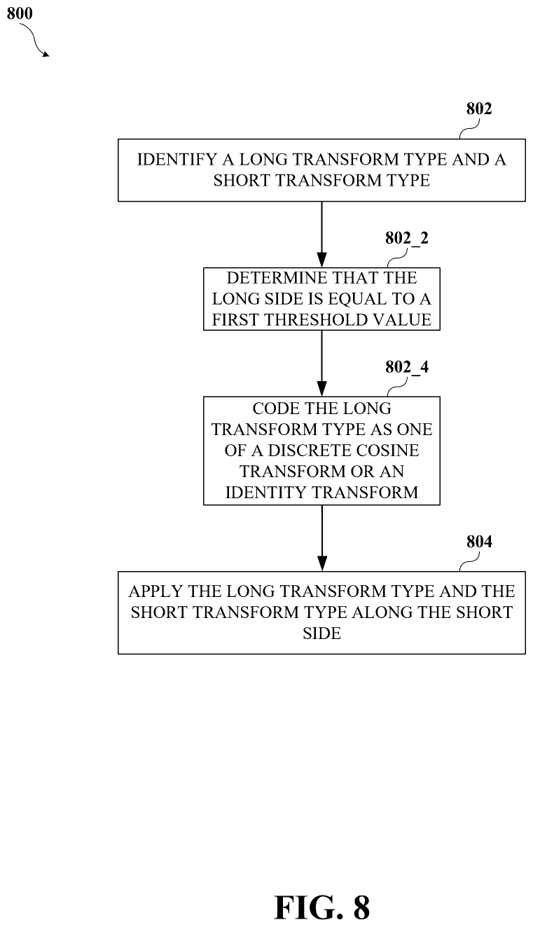

FIG. 8 is a flowchart of a technique 800 for coding a transform block. The technique 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 800. The technique 700 may be implemented in whole or in part in the transform stage 404 of the encoder 400 of FIG. 4 and/or the inverse transform stage 506 of the decoder 500 of FIG. 5. The technique 800 can be implemented using specialized hardware or firmware. Multiple processors, memories, or both, may be used. When the technique 800 is implemented by an encoder, the term “coding” includes encoding, such as in the compressed bitstream; and when the technique 800 is implemented by a decoder, the term “coding” includes decoding, such as from the compressed bitstream.

At 802, a long transform type to apply to a long side of the transform block and a short transform type to apply to a short side of the transform block are identified. The long side is set as the maximum of the width and the height of the transform block, and the short side is set as the minimum of the width and the height of the transform block. Identifying the long transform type and the short transform type can include steps 802_2 and 802_4.

At 802_2, the technique 800 determines whether the long side is equal to a first threshold value (e.g., 32) or a second threshold value (e.g., 64). In response to determining that the long side is equal to the first threshold value, at 802_4, the long transform type is coded as one of the discrete cosine transform (DCT) or the identity transform. If the long side is the height (width) of the transform block, then the identity transform is the horizontal (vertical) identity transform. In response to determining that the long side is equal to the second threshold value, the long transform type is set to the discrete cosine transform without coding, as only DCT is allowed for this size. As such, the long transform type can be encoded using a flag that can take on 2 possible values (i.e., 0 or 1) for the first threshold, or no signaling is required for the second threshold. When implemented at the encoder, the encoder selects the long transform type from one of DCT or an identity transform for the first threshold by optimizing a rate-distortion (RD) cost. The RD cost is computed as a combination of the distortion introduced by the transform type (e.g., measured as the difference between the original and reconstructed block) and the rate required to encode the transform type and associated coefficients, selecting the transform type that minimizes the RD cost.

As mentioned, coding the long transform type includes encoding the long transform type (e.g., encoding an indication thereof) in a compressed bitstream. When implemented at a decoder, coding the transform type includes decoding the long transform type (e.g., decoding the indication thereof) from the compressed bitstream. The long transform type may be entropy coded. As described above, the probability distribution for coding the long transform type can be based on whether the prediction block corresponding to the transform block is obtained using an inter prediction mode or an intra prediction mode. As such, coding the long transform type can include selecting a probability model for coding the long transform type where the probability model is selected based on whether a prediction block associated with the transform block is predicted using an inter prediction mode or an intra prediction mode.

Identifying the long transform type and the short transform type can include determining that the short side is equal to the first threshold value (e.g., 32) and, in response to determining that the short side is equal to the first threshold value, coding the short transform type as one of the discrete cosine transform or the identity transform; or determining that the short side is less than the first threshold value and, in response to determining that the short side is less than the first threshold value, coding the short transform type for the transform block, wherein the short transform type is one of the discrete cosine transform, an asymmetric discrete sine transform, a flipped asymmetric discrete sine transform, or the identity transform. For blocks with a long side equal to 64 and a short side less than or equal to 16, this results in the overall two-dimensional transform being one of DCT_DCT, ADST_DCT, FLIPADST_DCT, or H_DCT (for a horizontal short side) or DCT_DCT, DCT_ADST, DCT_FLIPADST, or V_DCT (for a vertical short side), since the long transform type is a discrete cosine transform.

At 804, the identified transform types are applied. That is, the long transform type is applied along the long side of the transform block and the short transform type is applied along the short side. When implemented at the encoder, the long transform type is applied along a long side of a residual block and the short transform type is applied along the short side of the residual block to obtain the transform block. When implemented at the decoder, the long transform type is applied along the long side of the transform block and the short transform type is applied along the short side of the transform block to obtain the residual block. Applying a transform type at the encoder and the decoder should be understood to mean that the transform type is applied at the encoder and its inverse is applied at the decoder.

FIG. 9 is a flowchart of a technique 900 for selecting a transform set based on the dimensions of a transform block. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 900. The technique 900 may be implemented in whole or in part in the transform stage 404 of the encoder 400 of FIG. 4 and/or the inverse transform stage 506 of the decoder 500 of FIG. 5. The technique 900 can be implemented using specialized hardware or firmware. Multiple processors, memories, or both, may be used.

The technique 900 receives the width and height of a transform block as input. When implemented by the encoder, the transform block may be generated by the transform stage 404, which determines the dimensions based on a partitioning of a residual block. When implemented by the decoder, the width and height may be decoded from a compressed bitstream, such as the compressed bitstream 420 of FIG. 4.

At 902, the technique 900 sets a variable LONG to the maximum of the width and height of the transform block and a variable SHORT to the minimum of the width and height. At 904, the technique 900 derives a square-up size and a square size based on the dimensions of the transform. The square-up size may represent a larger square size derived from the dimensions, while the square size may represent the actual square size of the transform block. For example, if a transform block has dimensions 64×16, the square-up size may be determined as 64, mapping the block to a predefined square size based on its larger dimension for the purpose of selecting an appropriate transform set.

The technique 900 then proceeds through a series of decisions to select a transform set. At decision block 906, the technique 900 checks if the square-up size is greater than 32. If yes, the technique 900 moves to decision block 908 to check if the square size is greater than or equal to 32. If the square size is greater than or equal to 32, the technique 900 moves to 912 to select a first transform set, which allows only DCT_DCT (e.g., for a 64× 64 block). If the square size is less than 32, the technique 900 moves to 914 to select a second transform set for blocks with a long side equal to 64, allowing transform types such as DCT_DCT, ADST_DCT, FLIPADST_DCT, H_DCT, and V_DCT.

If the square-up size is not greater than 32 at 906, the technique 900 moves to decision block 910 to check if the square-up size is equal to 32. If yes, it moves to decision block 918 to check if the square size is equal to 32. If the square size is equal to 32, the technique 900 moves to 922 to select a third transform set, allowing DCT_DCT and IDTX (e.g., for a 32× 32 block). If the square size is not equal to 32, the technique 900 moves to 924 to select a fourth transform set for blocks with a long side equal to 32, allowing transform types such as DCT_DCT, IDTX, H_DCT, V_DCT, ADST_DCT, FLIPADST_DCT, V_ADST, V_FLIPADST, H_ADST, and H_FLIPADST. If the square-up size is not equal to 32 at 910, the technique 900 moves to 920 to select additional transform sets for smaller blocks or other configurations.

At 916, the technique 900 outputs the assigned transform set, which defines the permissible transform types for the transform block. When implemented by the encoder, the selected transform set constrains the transform types available for selection in subsequent encoding steps, such as those described with respect to FIG. 7A, ensuring efficient compression by matching the transform types to the characteristics of the block. When implemented by the decoder, the selected transform set, which may be inferred from the dimensions of the transform decoded from the compressed bitstream, determines the transform types to be decoded and applied in the inverse transform stage, ensuring accurate reconstruction of the residual block.

The transform set selection process depicted in FIG. 9 can be implemented using a mapping function that evaluates the dimensions of the transform block to determine the appropriate transform set. An example implementation of this process is shown in the following pseudocode of Table IV, which derives a square-up size and a square size from the transform block's dimensions using predefined mappings (txsize_sqr_up_map and txsize_sqr_map) and selects a transform set based on the conditions outlined in the flowchart.

TABLE IV

| | |
|---|---|
| 1 | square_up_size = txsize_sqr_up_map[block_size]; |
| 2 | square_size = txsize_sqr_map[block_size]; |
| 3 | if (square_up_size > 32) { |
| 4 | return (square_size >= 32) ? First_Set : Second_Set; |
| 5 | } else if (tx_size_sqr_up == 32 ) { |
| 6 | return (square_size == 32) ? Third_Set : Fourth_Set; |
| 7 | } else |
| 8 | return Other_Set; // For smaller blocks/other configurations |

The mappings of transform block dimensions to square-up size and square size are exemplified in Table V. These mappings categorize transform blocks into predefined square sizes based on their dimensions, enabling efficient selection of transform sets as described in FIG. 9 and Table IV. The square-up size typically reflects the larger dimension mapped to a power-of-two square, while the square size reflects the smaller dimension or a categorized size, accommodating both square and rectangular blocks.

TABLE V

| Transform Block Size | Square-Up Size | Square Size |
|---|---|---|
| 64 × 64 | 64 × 64 | 64 × 64 |
| 32 × 32 | 32 × 32 | 32 × 32 |
| 16 × 16 | 16 × 16 | 16 × 16 |
| 64 × 16 | 64 × 64 | 16 × 16 |
| 16 × 64 | 64 × 64 | 16 × 16 |
| 32 × 16 | 32 × 32 | 16 × 16 |
| 16 × 32 | 32 × 32 | 16 × 16 |
| 64 × 8 | 64 × 64 | 8 × 8 |
| 8 × 64 | 64 × 64 | 8 × 8 |
| 32 × 8 | 32 × 32 | 8 × 8 |
| 8 × 32 | 32 × 32 | 8 × 8 |

For simplicity of explanation, the techniques 700, 750, 800, and 900 of FIGS. 7A, 7B, 8, and 9 are each depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available. A computer-readable medium may be a transitory computer-readable medium or a non-transitory computer-readable medium.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
identifying a long transform type to apply to a long side of a transform block and a short transform type to apply to a short side of the transform block, wherein identifying the long transform type and the short transform type comprises:
determining that the long side is equal to a first threshold value; and
in response to determining that the long side is equal to the first threshold value, coding the long transform type, the long transform type being one of a discrete cosine transform or an identity transform; and
applying the long transform and the short transform type.

2. The method of claim 1, wherein identifying the long transform type and the short transform type further comprises:
determining that the short side is equal to the first threshold value; and
in response to determining that the short side is equal to the first threshold value, coding the short transform type, the short transform type being one of the discrete cosine transform or the identity transform.

3. The method of claim 1, wherein identifying the long transform type and the short transform type further comprises:
determining that the short side is less than the first threshold value; and
in response to determining that the short side is less than the first threshold value, coding the short transform type for the transform block, the short transform type being one of the discrete cosine transform, an asymmetric discrete sine transform, a flipped asymmetric discrete sine transform, or the identity transform.

4. The method of claim 1, wherein coding the long transform type comprises:
selecting a probability model for coding the long transform type, wherein the probability model is selected based on whether a prediction block associated with the transform block is predicted using an inter prediction mode or an intra prediction mode.

5. The method of claim 1, wherein coding the long transform type for the transform block comprises:
encoding the long transform type into a compressed bitstream.

6. The method of claim 1, wherein coding the long transform type for the transform block comprises:
decoding the long transform type from a compressed bitstream.

7. The method of claim 1, wherein the long side is set as a maximum of a width and a height of the transform block, and the short side is set as a minimum of the width and the height of the transform block.

8. The method of claim 1, further comprising:
determining that a long side of another transform block is equal to a second threshold value; and
in response to determining that the long side of the another transform block is equal to the second threshold value, setting a long transform type for the another transform block to the discrete cosine transform.

9. A device, comprising:
a processor, the processor configured to execute instructions to:
identify a long transform type to apply to a long side of a transform block and a short transform type to apply to a short side of the transform block, wherein to identify the long transform type and the short transform type comprises to:
determine that the long side is equal to a first threshold value; and
in response to determining that the long side is equal to the first threshold value, code the long transform type, the long transform type being one of a discrete cosine transform or an identity transform; and
apply the long transform and the short transform type.

10. The device of claim 9, wherein to identify the long transform type and the short transform type further comprises to:
in response to determining that the short side is equal to the first threshold value, code the short transform type, the short transform type being one of the discrete cosine transform or the identity transform.

11. The device of claim 9, wherein to identify the long transform type and the short transform type further comprises to:
in response to determining that the short side is less than the first threshold value, code the short transform type for the transform block, the short transform type being one of the discrete cosine transform, an asymmetric discrete sine transform, a flipped asymmetric discrete sine transform, or the identity transform.

12. The device of claim 9, wherein to code the long transform type comprises to:
select a probability model for coding the long transform type, wherein the probability model is selected based on whether a prediction block associated with the transform block is predicted using an inter prediction mode or an intra prediction mode.

13. The device of claim 9, wherein to code the long transform type for the transform block comprises to:
encode the long transform type into a compressed bitstream.

14. The device of claim 9, wherein to code the long transform type for the transform block comprises to:
decode the long transform type from a compressed bitstream.

15. The device of claim 9, wherein the long side is set as a maximum of a width and a height of the transform block, and the short side is set as a minimum of the width and the height of the transform block.

16. The device of claim 9, wherein the processor is further configured to execute instructions to:
in response to determining that a long side of the another transform block is equal to a second threshold value, set a long transform type for the another transform block to the discrete cosine transform.

17. A non-transitory computer-readable storage medium, comprising executable instructions that, when executed by a processor, perform operations comprising:
identifying a long transform type to apply to a long side of a transform block and a short transform type to apply to a short side of the transform block, wherein identifying the long transform type and the short transform type comprises:
determining that the long side is equal to a first threshold value; and
in response to determining that the long side is equal to the first threshold value, coding the long transform type, the long transform type being one of a discrete cosine transform or an identity transform; and
applying the long transform and the short transform type.

18. The non-transitory computer-readable storage medium of claim 17, wherein identifying the long transform type and the short transform type further comprises:
determining that the short side is equal to the first threshold value; and in response to determining that the short side is equal to the first threshold value, coding the short transform type, the short transform type being one of the discrete cosine transform or the identity transform.

19. The non-transitory computer-readable storage medium of claim 17, wherein identifying the long transform type and the short transform type further comprises:
determining that the short side is less than the first threshold value; and
in response to determining that the short side is less than the first threshold value, coding the short transform type for the transform block, the short transform type being one of the discrete cosine transform, an asymmetric discrete sine transform, a flipped asymmetric discrete sine transform, or the identity transform.

20. The non-transitory computer-readable storage medium of claim 17, wherein coding the long transform type comprises:
selecting a probability model for coding the long transform type, wherein the probability model is selected based on whether a prediction block associated with the transform block is predicted using an inter prediction mode or an intra prediction mode.
